(19) United States
(12) Patent Application Publication
(10) Pub. No.: US 2006/0087837 A1
(43) Pub. Date: Apr. 27, 2006

(54) Lamp string

(76) Inventor: Chen-Yuan Chen, Hsinchu City (TW)

Correspondence Address: TROXELL LAW OFFICE PLLC;SUITE 1404, 5205 LEESBURG PIKE, FALLS CHURCH, VA, 22041, US

(21) Appl. No.: 10/968,894

(22) Filed: Oct. 21, 2004

(51) Int. Cl. B60Q 1/26

(52) U.S. Cl. 362/227

(57) ABSTRACT

A lamp string includes a plurality of skip-lightening lamp-bulb sockets and daughter lamp-bulb sockets all same by shape for inserting respectively therein skip-lightening lamp bulbs and daughter lamp bulbs; wherein the interior parts of the skip-lightening lamp-bulb sockets are matchable with the lower soft piths of the skip-lightening lamp bulbs, while the interior parts of the daughter lamp-bulb sockets are matchable with the lower soft piths of the daughter lamp bulbs; thereby the skip-lightening lamp bulbs and the daughter lamp bulbs can only be inserted in their matchable lamp bulb sockets.

### BACKGROUND OF THE INVENTION

1. Field of the Invention

The present invention is related to a lamp string, and especially to a lamp string with skip-lightening lamp-bulb sockets and daughter lamp-bulb sockets all same by shape for inserting respectively therein skip-lightening lamp bulbs and daughter lamp bulbs; the skip-lightening lamp bulbs and daughter lamp bulbs can only be inserted in lamp bulb sockets respectively matchable with them, thereby they are safe for use, convenient for changing, and are suitable to apply for using for ornament in various festivals.

2. Description of the Prior Art

In order to increase atmosphere of joy in festivals and holidays, people often hang lamp strings on trees or the peripheries of some articles to make outstanding of the articles and to beautify environment. A kind of lamp string normally sold in the markets presently includes skip-lightening lamp bulbs (mother lamp bulbs) and small lamp bulbs (daughter lamp bulbs), wherein every two mother lamp bulbs have therebetween a daughter lamp bulb, i.e., the mother lamp bulbs and the daughter lamp bulbs are arranged alternately; hence such lamp strings are normally called alternately skip-lightening lamp strings or segmentally skip-lightening lamp strings.

These well known alternately skip-lightening lamp strings are lively and beautiful, the shapes of the lamp bulb sockets of these lamp strings are basically same, that is to say, their mother lamp bulbs and daughter lamp bulbs can be mutually changed in use; if their skip-lightening lamp bulbs are damaged and can not be lightened, a customer may randomly take a spare lamp bulb (without discriminating whether it is a skip-lightening lamp bulb or a daughter lamp bulb) to inserted in a lamp bulb socket, this may induce accidence; because if the lamp bulb taken is wrong, and if there are quite a large amount of lamp bulbs that are inserted wrong, the lamp string bears an increased electric voltage and is subjected to inducing accidence, thereby this is not safe.

In view these, the inventor of the present invention contemplated to improve to solve the above stated problems, and studied and developed a structure of lamp string.

### SUMMARY OF THE INVENTION

The primary object of the present invention is to provide a lamp string with skip-lightening lamp-bulb sockets and daughter lamp-bulb sockets all same by shape for inserting respectively therein skip-lightening lamp bulbs and daughter lamp bulbs.

In order to achieve the above stated object, the lamp string provided by the present invention includes a plurality of skip-lightening lamp-bulb sockets and daughter lamp-bulb sockets all same by shape for inserting respectively therein skip-lightening lamp bulbs and daughter lamp bulbs; wherein the interior parts of the skip-lightening lamp-bulb sockets are matchable with lower soft piths of the skip-lightening lamp bulbs, while the interior parts of the daughter lamp-bulb sockets are matchable with lower soft piths of the daughter lamp bulbs; thereby the skip-lightening lamp bulbs and the daughter lamp bulbs can only be inserted in their matchable lamp bulb sockets.

The present invention will be apparent after reading the detailed description of the preferred embodiment thereof in reference to the accompanying drawings.

### BRIEF DESCRIPTION OF THE DRAWINGS

FIG. 1 is an analytic perspective view showing the embodiment of the present invention in use;

FIG. 2 is a sectional view showing the elements of the embodiment of the present invention;

FIG. 3 is a sectional schematic side view of a skip-lightening lamp-bulb socket of the embodiment of the present invention;

FIG. 4 is a top view of the skip-lightening lamp-bulb socket of the embodiment of the present invention;

FIG. 5 is a bottom view of the skip-lightening lamp-bulb socket of the embodiment of the present invention;

FIG. 6 is a sectional schematic side view of a lower soft pith of a skip-lightening lamp bulb of the embodiment of the present invention;

FIG. 7 is a bottom view of the lower soft pith of the skip-lightening lamp bulb of the embodiment of the present invention;

FIG. 8 is a sectional schematic side view of a daughter lamp-bulb socket of the embodiment of the present invention;

FIG. 9 is a top view of the daughter lamp-bulb socket of the embodiment of the present invention;

FIG. 10 is a bottom view of the daughter lamp-bulb socket of the embodiment of the present invention;

FIG. 11 is a sectional schematic side view of a lower soft pith of a daughter lamp bulb of the embodiment of the present invention;

### DETAILED DESCRIPTION OF THE PREFERRED EMBODIMENT

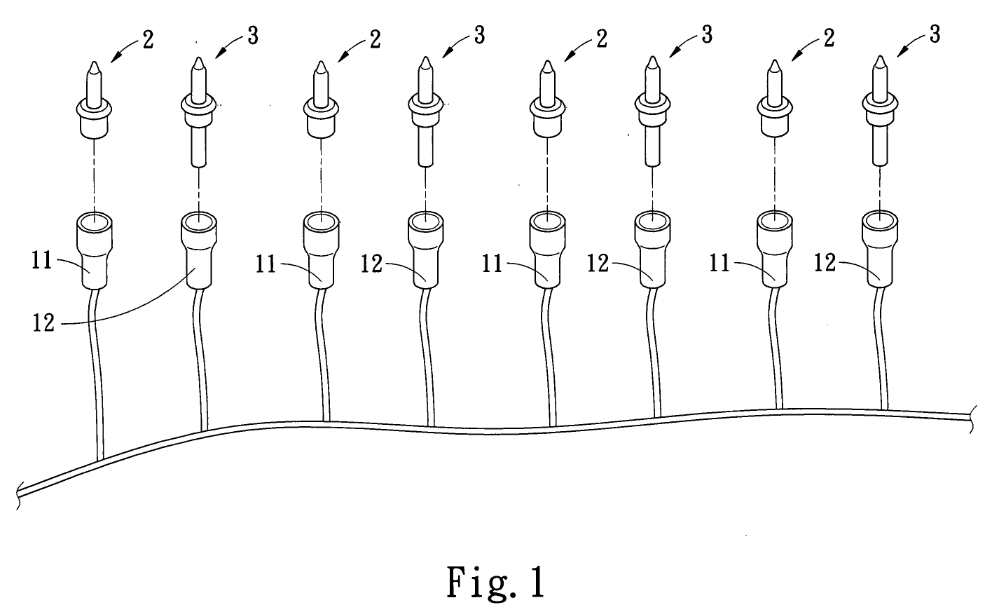

Referring firstly to FIG. 1 which shows an embodiment of a lamp string of the present invention, the lamp string comprises a plurality of skip-lightening lamp-bulb sockets 11 and daughter lamp-bulb sockets 12 all same by shape, each of the skip-lightening lamp-bulb sockets 11 is arranged between two of the daughter lamp-bulb sockets 12, the skip-lightening lamp-bulb sockets 11 and daughter lamp-bulb sockets 12 are for inserting respectively therein skip-lightening lamp bulbs and daughter lamp bulbs.

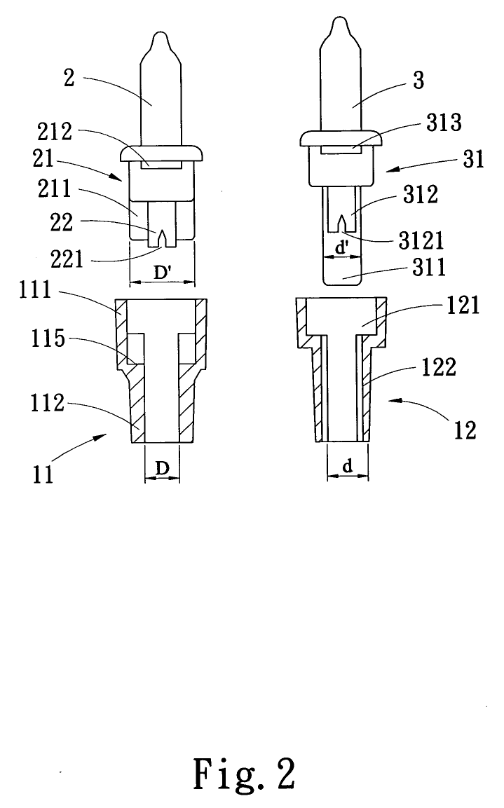

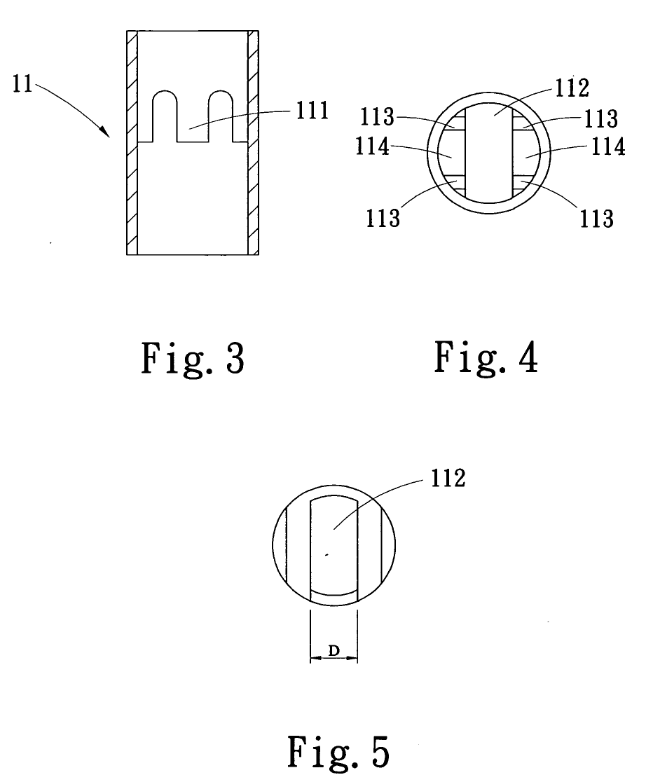

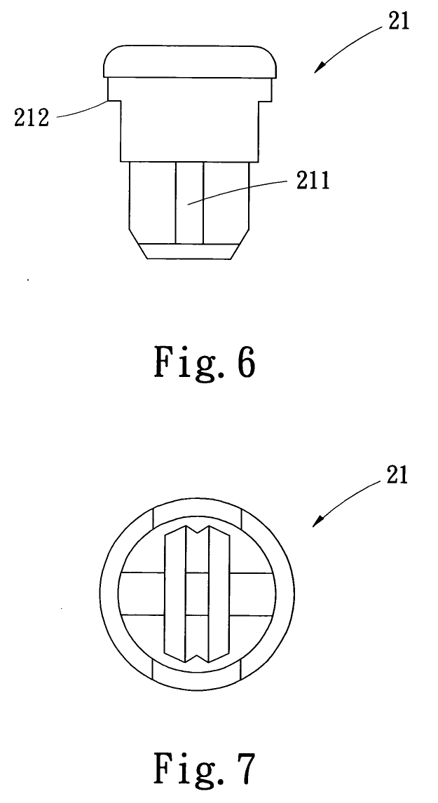

As shown in FIGS. 2-7, the interior parts of the skip-lightening lamp-bulb sockets 11 are matchable with lower soft piths 21 of skip-lightening lamp bulbs 2, so that the skip-lightening lamp bulbs 2 can be inserted in the skip-lightening lamp-bulb sockets 11. The interior parts of the skip-lightening lamp-bulb sockets 11 each has therein a stepped through hole of which the upper part is a round hole 111 and the lower part is an elongate hole 112. Areas on the wall of the round hole 111 along the width of and at least at one side of the elongate hole 112 have two ribs 113, a recess 114 is formed between the two ribs 113. The outside wall of each skip-lightening lamp-bulb socket 11 includes an upper and a lower part; the upper part is a round column part, while the lower part is a flat column part; the length of the transverse section of the flat column part is same as that of the round column part, but its width is smaller than that of the round column part. The lower soft piths 21 of the skip-lightening lamp bulbs 2 are provided each on the lower part of its outer wall with two protruding strips 211 that can be embedded in the recess 114 and are abutted against an upper end face 115 in a direction coincident with that of the elongate hole 112; a column part 22 for extending out lamp pins is located between the two protruding strips 211. When the lower soft piths 21 of the skip-lightening lamp bulbs 2 are inserted into the skip-lightening lamp-bulb sockets 11, the lower soft piths 21 of the skip-lightening lamp bulbs 2 are fixed to the skip-lightening lamp-bulb sockets 11 against moving by cooperation of the two protruding strips 211 and the recess 114. Moreover, the upper end of the lower soft pith 21 of each skip-lightening lamp bulb 2 is provided on their two lateral sides with an engaging platform 212 which can be engaged in the upper end of a skip-lightening lamp-bulb socket 11, in order that the lower soft pith 21 of the skip-lightening lamp bulb 2 can be conveniently taken out of the skip-lightening lamp-bulb socket 11.

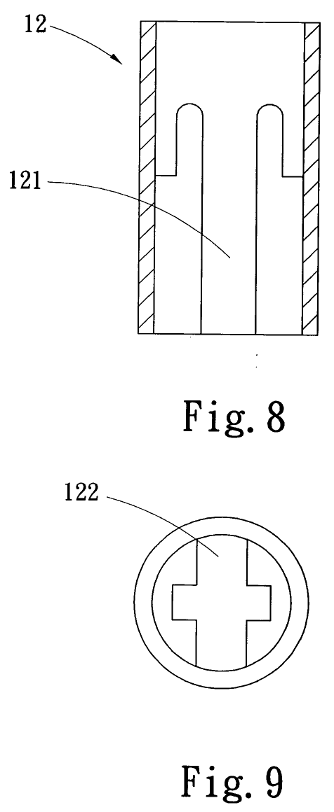

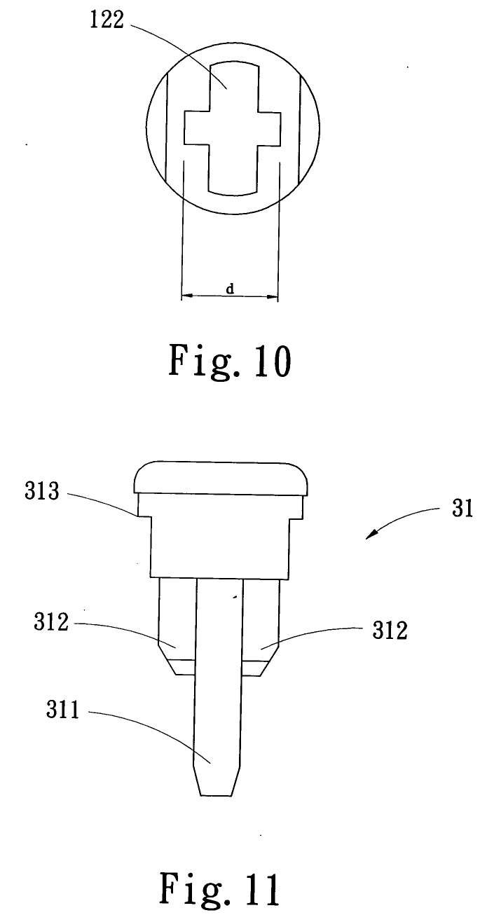

As shown in FIGS. 2, 8-11, the interior parts of the daughter lamp-bulb sockets 12 are matchable with lower soft piths 31 of a plurality of daughter lamp bulbs 3; the interior parts of the daughter lamp-bulb sockets 12 each has therein a stepped through hole of which the upper part is a round hole 121 and the lower part is a cross hole 122. The outside wall of each daughter lamp-bulb sockets 12 also includes an upper and a lower part; the upper part is a round column part, while the lower part is a flat column part; the length of the transverse section of the flat column part is same as that of the round column part, but its width is smaller than that of the round column part. The lower soft piths 31 of the daughter lamp bulbs 3 are provided each in the middle of its lower part with a prolonged partition 311; the partition 311 is provided on its front and rear sides with a column part 312 for extending out lamp pins, the partition 311 and the column part 312 for extending out the lamp pins can be embedded correspondingly in the cross hole 122 of a daughter lamp-bulb socket 12; while the partition 311 can directly extend to the bottom of the daughter lamp-bulb socket 12 to prevent water from entering to form circuit shorting. And the upper end of the lower soft pith 31 of each daughter lamp bulb 3 is provided on their two lateral sides with an engaging platform 313 which can be engaged in the upper end of the daughter lamp-bulb socket 12, in order that the lower soft pith 31 of the daughter lamp bulb 3 can be conveniently taken out of the daughter lamp-bulb socket 12.

Moreover, the width D of the interior elongate hole 112 on the lower part of each skip-lightening lamp-bulb socket 11 is smaller than a transverse width d′ of the prolonged partition 311 of the lower soft pith 31 of each daughter lamp bulb 3, and is smaller than a length D′ between the two protruding strips 211 of the lower soft pith 21 of each skip-lightening lamp bulb 2; so that the lower soft pith 21 of the skip-lightening lamp bulb 2 can be supported on the upper end face 115 on the wall of the elongate hole 112; while the length D′ between the two protruding strips 211 of the lower soft pith 21 of the skip-lightening lamp bulb 2 is larger than a transverse width d of the cross hole 122 in the direction as that of the prolonged partition 311, but is smaller than the diameter of the round hole 111 on the upper part of the skip-lightening lamp-bulb socket 11. For example, we can make the width D of the interior elongate hole 112 of the skip-lightening lamp-bulb socket 11 be 3.0 mm, make the length D′ between the two protruding strips 211 of the lower soft pith 21 of the skip-lightening lamp bulb 2 be 6.6 mm, make the transverse width d of the cross hole 122 of the daughter lamp-bulb socket 12 in the direction as that of the prolonged partition 311 be 4.3 mm, and make the transverse width d′ of the prolonged partition 311 of the lower soft pith 31 of the daughter lamp bulb 3 be 4 mm; thereby it is guaranteed that the lower soft pith 21 of the skip-lightening lamp bulb 2 is only able to insert into the skip-lightening lamp-bulb socket 11, and the lower soft pith 31 of the daughter lamp bulb 3 is only able to insert into the daughter lamp-bulb socket 12; this gets the object of avoiding being commonly used of the skip-lightening lamp bulbs 2 and the daughter lamp bulbs 3 to thereby assure safety of using. Certainly, the inner and outer walls of the skip-lightening lamp-bulb sockets 11 and the daughter lamp-bulb sockets 12 can have angles slightly declined downwards from above, the outer walls of the lower soft piths 21 of the skip-lightening lamp bulbs 2 and the lower soft piths 31 of the daughter lamp bulbs 3 can also have angles slightly declined downwards from above, so that convenience of mounting can be obtained.

Further, the column parts 22, 312 for extending out the lamp pins of the lower soft piths 21 of the skip-lightening lamp bulbs 2 and of the lower soft piths 31 of the daughter lamp bulbs 3 have at their bottoms extending-out ends 221, 3121 respectively, in order that the lamp pins of the skip-lightening lamp bulbs 2 and the daughter lamp bulbs 3 can be extended out for use (as shown in FIG. 2).

Therefore, the lamp string provided by the present invention can have its skip-lightening lamp bulbs 2 and daughter lamp bulbs 3 inserted respectively into their matchable lamp-bulb sockets 11, 12, hence wrong insertion of the skip-lightening lamp bulbs 2 and the daughter lamp bulbs 3 can be avoided; it is very safe in use, and the appearances of the skip-lightening lamp-bulb sockets 11 and the daughter lamp-bulb sockets 12 are same, the entire appearance of the lamp string is more beautiful.

Accordingly, the above contents can get the expected object of the present invention to provide a lamp string structure which undoubtedly has valuable practicability.

The above stated are only for illustrating a preferred embodiment of the present invention, and not for giving any limitation to the scope of the present invention. It will be apparent to those skilled in this art that various equivalent modifications or changes without departing from the scope of this invention shall fall within the scope of the appended claims.

Therefore, what I claim as new and desire to be secured by Letters Patent of the United States are:

1. A lamp string comprising a plurality of skip-lightening lamp-bulb sockets and daughter lamp-bulb sockets all same by shape for inserting respectively therein skip-lightening lamp bulbs and daughter lamp bulbs; wherein interior parts of said skip-lightening lamp-bulb sockets are matchable with lower soft piths of said skip-lightening lamp bulbs, while interior parts of said daughter lamp-bulb sockets are matchable with lower soft piths of said daughter lamp bulbs; thereby said skip-lightening lamp bulbs and said daughter lamp bulbs are adapted only to inserting respectively in said matchable skip-lightening lamp-bulb sockets and said daughter lamp-bulb sockets.

2. The lamp string as in claim 1, wherein: said interior parts of said skip-lightening lamp-bulb sockets each has therein a stepped through hole of which an upper part is a round hole and a lower part is an elongate hole; areas on a wall of said round hole along the width of and at least at one side of said elongate hole have two ribs, a recess is formed between said two ribs.

3. The lamp string as in claim 2, wherein: said lower soft piths of said skip-lightening lamp bulbs are provided each on a lower part of its outer wall with two protruding strips that are adapted to embedding in said recess and abutted against an upper end face in a direction coincident with said width of said elongate hole.

4. The lamp string as in claim 1, wherein: said interior parts of said daughter lamp-bulb sockets each has therein a stepped through hole of which an upper part is a round hole and a lower part is a cross hole.

5. The lamp string as in claim 4, wherein: said lower soft piths of said daughter lamp bulbs are provided each in the middle of a lower part thereof with a prolonged partition; said partition is provided on its front and rear sides with a column part, said partition and said column part for extending out said lamp pins are adapted for embedding correspondingly in said cross hole of one of said daughter lamp-bulb sockets.

6. The lamp string as in claim 5, wherein: said partition directly extends to a bottom of said daughter lamp-bulb socket.

7. The lamp string as in claim 5, wherein: width of said elongate hole on said lower part of each of said skip-lightening lamp-bulb sockets is smaller than a transverse width of said prolonged partition of one of said lower soft piths of said daughter lamp bulbs, while length between said two protruding strips of each of said lower soft piths of said skip-lightening lamp bulbs is larger than a transverse width of said cross hole in the direction as that of said prolonged partition.

8. The lamp string as in claim 1, wherein: upper ends of each of said lower soft piths of said skip-lightening lamp bulbs and of said daughter lamp bulbs are provided on their two lateral sides each with an engaging platform, said engaging platforms are adapted to engaging respectively in upper ends of said skip-lightening lamp-bulb socket and said daughter lamp-bulb socket.

9. The lamp string as in claim 1, wherein: each of said skip-lightening lamp-bulb sockets is arranged between two of said daughter lamp-bulb sockets.
